(19) United States
(12) Patent Application Publication
(10) Pub. No.: US 2021/0049850 A1
(43) Pub. Date: Feb. 18, 2021

(54) CHECKING ACCESS AUTHORIZATIONS USING MOBILE CONTROL DEVICES

(71) Applicant: INVENTIO AG, Hergiswil (CH)

(72) Inventors: Paul FRIEDLI, Remetschwil (CH); Florian TROESCH, Zurich (CH)

(21) Appl. No.: 16/080,471

(22) PCT Filed: Feb. 27, 2017
(86) PCT No.: PCT/EP2017/054447

§ 371 Date: Aug. 28, 2018

(30) Foreign Application Priority Data
Feb. 29, 2016 (EP) 16157907.3

(51) Int. Cl. G07C 9/29; G06K 7/14; G06K 7/10; G07C 9/20

(52) U.S. Cl. CPC G07C 9/29; G07C 9/20; G06K 7/10722; G06K 7/1417

(57) ABSTRACT

The invention relates to a method for checking an access authorization to a building and/or a facility. The method includes receiving an access authorization from a configuration device, said access authorization being valid for a participant invited into the building and/or to the facility, generating a machine-readable code on the basis of the access authorization of the invited participant, transmitting the machine-readable code to a participant mobile device of the participant, reading the machine-readable code by means of a control device and decoding the machine-readable code, checking whether the machine-readable code authorizes the participant to access the building and/or the facility, ascertaining participant information on the basis of machine-readable code, and displaying the participant information by means of the control device such that the participant information can be checked with respect to the participant by a controller.

### CROSS-REFERENCE TO RELATED APPLICATION

This application is the national phase application under 35 U.S.C. § 371 claiming the benefit of priority based on International Patent Application No. PCT/EP2017/054447, filed on Feb. 27, 2017, which claims the benefit of priority based on European Patent Application No. 16157907.3, filed on Feb. 29, 2016. The contents of each of these applications are herein incorporated by reference.

### FIELD OF THE INVENTION

Embodiments of the technology described here relate to a method, a computer program, a computer-readable medium and a system for checking an access authorization to a building and/or an event.

### BACKGROUND OF THE INVENTION

In order to grant a person access to a building, an electronic access ticket can be sent to a mobile telephone of the person. At the access point to the building, the access ticket can be read in and access can be granted if the access ticket is valid. WO 2015/049186 A1 relates, for example, to a two-dimensional color code which can be displayed by a mobile telephone on the display thereof and used for the purposes of access control.

US 2012/0068818 A1 relates to an access control system in which an identification code can be sent to an access node by means of a mobile telephone. If the access code is valid, an access code that can be displayed on a display and detected and evaluated by a camera is sent to the mobile telephone.

There may be a general need to grant people access to a building and/or event in a secure manner by means of a code sent to a portable mobile telephone. There may also be the need to reduce misuse of electronic access tickets.

Such needs may be addressed by the subject matter of the independent claims. Advantageous embodiments are defined in the dependent claims.

### SUMMARY OF THE INVENTION

One aspect of the invention relates to a method for checking an access authorization to a building and/or an event. The method may for example be executed by a system that comprises a server and a control device, which are interconnected via a data communication connection. The server may be a cloud server (i.e. can be emulated by a plurality of hardware devices). The control device may be a stationary device or a portable device which is operated by a controller (a person).

According to an embodiment of the invention, the method comprises: generating a machine-readable code based on an access authorization of a participant invited into the building and/or to the event.

Data relating to access authorizations to the building and/or event may for example be stored on the server. An access authorization may for example define the rooms and/or locations in a building to which access is granted. Furthermore, an access authorization may define the times (such as a particular date, a particular time frame) at which access is granted.

Furthermore, a participant can be assigned to each access authorization. A participant (a person) may be represented by data in the server that define the participant. For example, said data may comprise a name, telephone number and/or e-mail address of the participant.

The server can then generate a machine-readable code, in which the access authorization is encoded, based on the access authorization. For example, the access authorization may comprise a unique number which is encoded into the machine-readable code. It is also possible for additional data to be encoded into the machine-readable code, such as a number of the event, data relating to the event (location, time, etc.), a participant number, data relating to the participant (name, participant information, see below) etc.

The machine-readable code may be based on a graphic which can be read in and/or scanned in by a device (in this case the control device) and then decoded again into the data encoded in the machine-readable code. For example, the machine-readable code may be stored in a graphic file (gif, png, etc.). The machine-readable code may be a bar code, a two-dimensional code (such as a QR code) or a code as described in WO 2015/049186 A1.

According to an embodiment of the invention, the method further comprises: sending the machine-readable code to a participant mobile device of the participant. The access authorization may contain a reference to a participant that allows the participant to be sent a message (such as an electronic invitation) electronically. For example, the server may send an e-mail or an MMS containing an electronic invitation to the participant, in which electronic invitation the machine-readable code is also contained.

According to an embodiment of the invention, the method further comprises: reading in the machine-readable code displayed for example by the participant mobile device by means of a control device and decoding the machine-readable code. If the participant has reached the building and/or event, access control can take place, which is carried out by a controller who is assisted by the system consisting of the server and control device.

The participant for example displays the machine-readable code sent to them on the display of their mobile device and the controller reads and/or scans the machine-readable code using the control device. However, it is also possible for the participant to print out the machine-readable code and to present it to the controller in this manner.

The control device, which for example comprises a scanner and/or a camera, then generates scanner data and/or image data from the machine-readable code again, which code can then be converted back into the data encoded in the machine-readable code. For example, the control device can implement this itself or can send the scanner data and/or image data to the server, which then decodes said data.

According to an embodiment of the invention, the method further comprises: automatically checking whether the machine-readable code authorizes the participant to access the building and/or event and identifying participant information based on the machine-readable code. Using the data encoded in the machine-readable code, for example a unique number of the access authorization and/or of the participant, the server can then identify the associated access authorization and check whether said access authorization authorizes access. Said information can be sent by the server to the control device and displayed thereon and/or output in the form of an audible tone.

Furthermore, the server can send participant information to the control device based on the access authorization and the associated participant. Said participant information may for example comprise a name (first name and/or surname), but also personal characteristics of the participant (such as eye color, hair color, gender, height, a face image, etc.) that can be checked by the controller.

According to an embodiment of the invention, the method further comprises: displaying the participant information by means of the control device, such that the participant information can be checked by a controller with respect to the participant. While the validity of the machine-readable code can be automatically checked, the controller can check or ascertain whether it is plausible that the person providing the machine-readable code really is the person stored on the server. For this purpose, the controller can read off the participant information from the control device and compare said information with the appearance of the participant and/or their statements.

The infrastructure for granting people access to an event and/or meeting in a flexible but secure manner can be provided by the system. For example, mobile access points to the building and/or event can be set up by means of the control devices, at which access points a plurality of participants can be checked by controllers (for example security personnel).

The participants must for example present their electronic invitations, which are found on their mobile telephones, i.e. participant mobile device, to the controllers and/or control devices, which are equipped with mobile scanners and/or cameras, for example, in order to verify the validity of the invitation. This takes place by means of automatic verification of the machine-readable code and personal verification by means of the controller with reference to the participant information.

According to an embodiment of the invention, the method further comprises: storing data relating to the access authorization on a server if the access authorization has been generated for the participant and sending an electronic invitation to the participant mobile device of the participant after storage, the electronic invitation containing the machine-readable code. For example, a host can define an event on the server and then assign participants to said event. Based on said information, the server can generate access authorizations and then send same to the participants, for example in the form of an electronic invitation, which also contains the machine-readable code (as a graphic) in addition to information that can be read by the participant. The electronic invitation can be sent to the participant or to the mobile device thereof before the participant has reached an access point at which they are inspected.

According to an embodiment of the invention, the server and/or control device check(s) whether the machine-readable code authorizes access. The control device can read in the machine-readable code (for example using a scanner and/or camera). The raw data generated can be decoded directly by the control device and the decoded data of the machine-readable code can be sent from the control device to the server. Alternatively or additionally, it is also possible for the raw data generated to be sent from the control device to the server and then decoded by the server.

According to an embodiment of the invention, participant information for participants can be stored on the server, the server identifying the participant information assigned to the machine-readable code and sending said information to the control device. The participant information does not have to be encoded in the machine-readable code, but rather can be stored as profile data relating to the participant on the server. The server can identify the participant information and then send same to the control device using a unique number of the access authorization and/or of the participant, which may be encoded in the machine-readable code.

According to an embodiment of the invention, the machine-readable code is a graphical code. The machine-readable code may be a one- or two-dimensional code that can encode numerical values using various graphical elements (dashes, check-boxes, etc.). For example, data in the machine-readable code can be encoded in a two-dimensional matrix. In particular, the machine-readable code can be captured by means of a camera of the control device and the image data generated by the camera can be decoded.

According to an embodiment of the invention, the participant information is intended to be personally checked by the controller. For example, the participant information may comprise a first name, a surname, an image and/or a personal characteristic of the participant. A personal characteristic of the participant may for example be their eye color, hair color, height, stature, gender, etc., which can be visually checked by the controller.

According to an embodiment of the invention, the control device is a (for example, portable) mobile device. The control devices may on the one hand be installed in a fixed manner, but on the other hand may be designed to be held in the hand of a controller.

In general, a host device (by means of which a host communicates with the server and/or configures the access authorizations), a participant mobile device and/or the control device may be a portable mobile device, for example a smartphone, a tablet computer, a smartwatch, etc.

According to an embodiment of the invention, the method further comprises: generating an additional machine-readable code in response to the machine-readable code read in first being recognized as valid during checking; sending the additional machine-readable code to the participant mobile device; reading in the machine-readable code displayed by the participant mobile device by means of the control device and decoding the additional machine-readable code; (automatically) checking whether the additional machine-readable code authorizes access to the building and/or event. By sending an additional machine-readable code to the mobile device carried by the participant, it can additionally be checked whether the carried mobile device is linked to the access authorization.

According to an embodiment of the invention, a validity of the additional machine-readable code is limited in time. For example, the additional machine-readable code can only be used within a time window (of approximately 5 minutes) after generation in order to gain access to the building and/or event.

According to an embodiment of the invention, the method further comprises: marking the access authorization as used if the machine-readable code has been checked. The access authorization stored on the server may comprise a data field in which information is stored as to whether the corresponding participant has already been granted access by means of this access authorization. In this way, it can be ensured that an access authorization cannot be used multiple times. After the machine-readable code presented by the participant has been read in, the control device can also show that the access authorization has already been used if the same machine-readable code is checked again.

According to an embodiment of the invention, the method further comprises: defining an event using an application run on a server, a plurality of participants being assigned to the event. A host may for example define an event, i.e. a name, location and/or time of the event, by means of the application, which may for example be provided for download from the server. Said data can then be stored on the server. Furthermore, participants can be assigned to an event. Profiles of the participants may, for example, already be stored on the server and/or linked to the event.

According to an embodiment of the invention, the method further comprises: sending an electronic invitation containing the machine-readable code to a participant mobile device of each of the participants, machine-readable codes of various participants differing from one another. If an event has been defined and participants have been assigned to the event, the server can create access authorizations for said participants. Based on the access authorizations, the server can generate machine-readable codes (for example by encoding a unique number for the access authorization) and send said codes to the participants, which codes differ from one another for each participant.

According to an embodiment of the invention, the method further comprises: assigning a participant to a participant category when defining the event and sending the participant category of a participant determined from the machine-readable code to the control device in response to the machine-readable code being checked. The host can also assign the participants of an event to various categories (such as VIP guests who are allowed to step foot in special areas that other participants are not allowed to step foot in). Said categories may then be displayed to the controller on the control device.

Additional aspects of the invention relate to a computer program which, when executed on one or more processors, is designed to carry out the method as described above and below, and to a computer-readable medium on which a computer program of this kind is stored.

A computer-readable medium may in this case be a floppy disk, a hard disk, a USB storage device, a RAM, a ROM or an EPROM. A computer-readable medium may also be a data communication network, such as, for example, the Internet, that permits downloading of a program code.

The computer program may for example be executed by the server and/or the control device, it being possible for program components, for example, that are executed on the control device to be provided by the server for download.

An additional aspect of the invention relates to a system for checking an access authorization to a building and/or an event. The system may comprise a server, on which a plurality of access authorizations are stored, each access authorization being assigned to a participant and linked to participant information for said participant. For example, said access authorizations may be set up on the server by a host in a building and/or of the event. For this purpose, the host may access the server using a host mobile device or host PC (or similar device) and create the access authorizations by means of a corresponding application (which can be provided by the server for download).

Furthermore, the system may comprise a control device (for example in another mobile device) that is designed to exchange information with the server, the server being designed to generate a machine-readable code based on one of the access authorizations and to send said code to a participant mobile device of the assigned participant.

After the host has created the access authorization, the server can generate the machine-readable code and send same together with an electronic invitation to a mobile device of the participant (that is registered on the server with an e-mail and/or telephone number, for example).

The control device can then read in a machine-readable code displayed by the participant mobile device, such that the system (for example, the control device itself or the server) can decode the machine-readable code. Furthermore, the server may then for example check whether the machine-readable code authorizes the participant to access the building and/or event.

Moreover, the control device may be designed to display participant information that was identified based on the read-in machine-readable code, such that the participant information can be checked by a controller with respect to the participant. For example, after the server has checked whether the machine-readable code authorizes access, the server can send additional information via the participant, who is assigned to the access authorization by means of the machine-readable code, to the control device. Said information can then be checked by a controller, who for example carries and/or operates the control device, with reference to the participant.

It should be understood that features of the method may also be features of the computer program, computer-readable medium and/or system (and vice versa).

It should further be noted that some of the possible features and advantages of the invention are described here with reference to different embodiments. A person skilled in the art shall recognize that the features may be combined, adapted, or exchanged as appropriate in order to arrive at other embodiments of the invention.

### BRIEF DESCRIPTION OF THE DRAWINGS

Embodiments of the invention will be described below with reference to the accompanying drawings, neither the drawings nor the description being intended to be interpreted as limiting the invention.

FIG. 1 schematically shows a system according to an embodiment of the invention.

FIG. 2 schematically shows an event in which the system from FIG. 1 can be used.

FIG. 3 is a flow diagram showing a method that can be carried out by the system from FIG. 1.

The drawings are merely schematic and not true to scale. Like reference signs refer in different drawings to like or analogous features.

### DETAILED DESCRIPTION OF EMBODIMENTS OF THE INVENTION

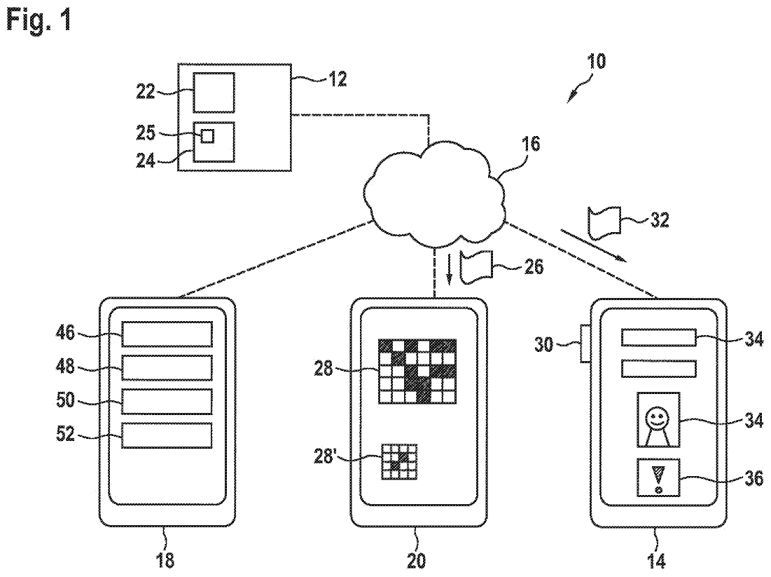

FIG. 1 shows a system 10 for checking an access authorization to a building and/or an event. The system comprises a server 12 and a control device 14, which are interconnected via a data communication network 16, for example the Internet and/or a telecommunications network for mobile telephones.

Furthermore, a host configuration device 18 and a participant mobile device 20 can be connected to the server 12 via the data communication network 16.

The server 12 may be a cloud server, i.e. it can be emulated by a plurality of hardware devices. An application (computer program) 22 may be run on the server 12, on which application a host can define and/or configure events by means of the configuration device 18 and communicate said events using the participant mobile device 20 and the control device 14, in order to check the access of participants to said events or to assist in the checking thereof. Furthermore, a database 24 may be run on the server 12, in which database data are stored, which are managed by the application 22.

In particular, the database 24 can manage access authorizations 25 by means of which the access of people or participants to a building and/or to an event can be managed.

The devices 14, 18, 20 may for example all be portable mobile devices, for example smartphones, tablet computers or smartwatches, etc.

The application 22 may for example comprise a web application which can be called by means of the configuration device 18 and by means of which the host can plan and configure an event and invite the participants to said event. Based on said information, the application can then generate the access authorizations 25.

The application 22 sends an electronic invitation 26 to the mobile devices 20 of the participants based on said data and in particular an access authorization 25, which electronic invitation contains a machine-readable code 28 which can be shown on a display of the mobile device. Data for the access authorization 25 of the relevant participant are encoded in the machine-readable code 28.

The machine-readable code 28 can be read in by means of a camera 30 of the control device 14. The image data produced can be decoded and based on this the application 22 can decide whether access to the event can be granted based on the machine-readable code 28. Furthermore, the application 22 can send participant information 32 to the control device 14 based on the machine-readable code 28, which information can be shown on a display of the control device. For example, personal characteristics 34 of the participant can be displayed in text form and/or as an image on the display of the control device 14. The control device 14 can also show that the machine-readable code 28 authorizes access using a symbol 36 (and/or using an acoustic signal).

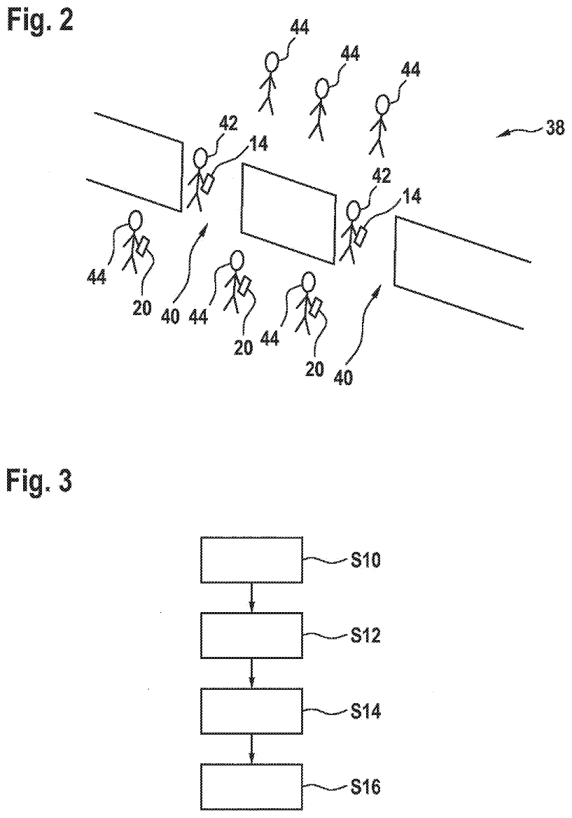

FIG. 2 schematically shows an event 38 to which access can be granted via a plurality of access points 40. A controller 42 checks participants 44 using a portable control device 14 at each access point 40. For this purpose, the participants 44 can for example present the machine-readable code 28 sent to them together with the electronic invitation 26 on their mobile device 20, the controller 42 reads in the machine-readable code 28 using the control device 14, which then checks, by querying the server 12, whether access can be granted to the participant 44 based on the machine-readable code 28.

Furthermore, based on the machine-readable code 28, participant information 32 can be sent to the control device 14, which information contains personal characteristics 34 of the participant 44, who is linked to the access authorization 25 on the server 12. This information is displayed to the controller 42 on the control device, who personally checks whether the personal characteristics 34 match the participant 44 who has presented the machine-readable code 28. Based on this, the controller 42 can decide whether the participant 44 should be granted access or not.

FIG. 3 shows a method for checking an access authorization 25 to an event 38 and/or a building in which the event 38 takes place. The method can be carried out by the system 10.

In step S10, an event 38 is defined on the server 12 using the application 22. The application 22 can provide a web interface to which the host can gain access via the data communication network 16 using a mobile device 18. For example, the host of the event 38 can create an event, assign a name thereto and create additional master data 46 (see FIG. 1) for the event.

Furthermore, the host can plan the event 38 or generate plan data 48 and assign one or more locations (for example in a particular building) and/or times (date, starting time, end time, etc.) to the event 38.

Moreover, the host can assign a plurality of participants 44 to the event 38 by creating links 50 to participants 44. For example, profiles 52 of the participants 44 can be created using the application 22, which profiles can then be linked to an event 38.

It should be understood that the data 46, 48, 50, 52 (as shown in FIG. 1) can be displayed on the device 18 of the host and edited, but all of said data are stored by means of the application 22 in the database 24.

The name (first name, surname) of the participant 44 and their contact data (such as e-mail, telephone number, etc.) can be stored in the participant profile 52. In addition, further participant information 32 for the relevant participant 44 may be stored in the participant profile 52, for example personal characteristics 34, such as an image of the participant and additional characteristics (such as eye color, gender, hair color) of the participant 44 that can be easily checked by a controller.

During or after the host has created and/or updated the data 46, 48, 50, 52, the server generates access authorizations 25 for the participant 44 based on the links 50 of the participant profiles 52 to the event 38. An access authorization 25 may for example define which locations a particular participant 44 has access to at specific times, or contain data relating thereto. Data relating to the access authorizations 25 may be stored by the application 22 in the database 24.

In step S12, machine-readable codes 28 are generated by the application 22 based on the access authorizations 25 of an event 38 (i.e. for each of the participants 44 of an event 38). The machine-readable codes 28 can each be stored in a graphic file (e.g. gif or png).

The machine-readable code 28 can encode data which may contain information on the event 38 and/or the participant 44. For example, a unique number may be assigned to the event 38, the participant 44 and/or the access authorization 25. For example, the unique number of the event 38 and of the participant 44 may be encoded in the machine-readable code 28. The unique number of the access authorization 25 may also be encoded in the machine-readable code 28. It is possible for additional information from the data 46, 48, 50, 52 to be encoded in the machine-readable code 28.

It is clear that machine-readable codes 28, which are based on various participants 44 or various access authorizations 25, differ from one another (optically and in terms of content), since different data are encoded in each one.

Subsequently, the machine-readable codes 28 are sent to mobile devices 20 of the participants 44. For example, the application 22 can generate an electronic invitation 26 in the form of a message that can be sent via the network 16 and contains the machine-readable code 28 as a web link or attachment. The message may, for example, be sent to the e-mail address and/or telephone number stored in the participant profile 52 of the associated participant 44.

The event 38 is at this point fully planned from the point of view of the application 22, and all participants 44 have been invited. The following steps are then carried out if a participant 44 approaches an access point 40 and/or a controller 42 and their control device 14.

However, during the event 38, the steps S10 and S12 can be carried out again if, for example, additional participants are intended to be invited at a later point.

In step S14, a machine-readable code 28 that is displayed on a participant mobile device 20 is read in by a control device 14 and then decoded. For example, the machine-readable code 28 is converted into image data by a camera 30 of the control device 14, which image data are then either converted into data encoded in the machine-readable code 28, by the control device 14 itself, or are sent to the server 12 or application 22 in order to be decoded on the server 12.

By means of the data (such as unique numbers) stored in the machine-readable code 28, the application 22 can then determine for which access authorization 25 the machine-readable code 28 has been generated. Using said access authorization 25, the application 22 can then check whether the machine-readable code 28 authorizes the participant 44 to access the building and/or event 38 (in particular at this time).

In response to recognizing a valid machine-readable code 28 (i.e. a code which authorizes the participant 44 to access the event 38 and/or building), the application 22 can also send an additional machine-readable code 28′ (see FIG. 1) that is only valid for a short period of time to the participant mobile device 20, which additional code can be evaluated by the control device 14 again.

Said additional machine-readable code 28′ may be based on the same coding principle as the code 28.

The participant 44 can then present the additional machine-readable code 28′ to the controller after receiving same via the mobile device 20. The additional machine-readable code 28′ can then be read in by the control device 14 and subsequently decoded, it being possible to check whether the additional machine-readable code 28′ confirms the previously presented machine-readable code 28.

In step S16, participant information 32 is determined based on the machine-readable code 28 by means of the application 22 and sent to the control device 14. Information that may assist the controller when checking the participant 44 is compiled from the profile 52 of said participant based on the access authorization 25 linked to the machine-readable code 28 and/or based on the participant 44.

For example, specific predefined personal characteristics 34 can be read from the profile 52 for the participant information 32 and sent to the control device 14.

The participant information 32 and in particular the personal characteristics 34 are displayed using the control device 14, such that the participant information 32 can be checked by a controller 42 with respect to the participant 44.

For example, the controller 42 can ask the participant 44 for their first name and/or check whether it is the participant 44 using an image.

It is possible for the controller 42 to specify, using the control device 14, that the participant 44 has been granted access. Said information can be sent to the application 22 and stored in the access authorization 25. The access authorization 25 may be marked as “used” if the machine-readable code 28 has been checked and/or if said code has been confirmed by the controller. The control device 14 can show that an access authorization 25 has already been used if the same machine-readable code 28 is checked again.

It is also possible in step S10 for the host to assign a participant 44 for an event 38 to a particular participant category. In step S16, the participant category of the participant 44 determined from the machine-readable code 28 can be sent to the control device 14 in response to the machine-readable code 28 being checked. The controller 42 can thus recognize that the participant 44 should for example be treated in a particular manner, for example be accompanied to a VIP area.

Finally, it should be noted that terms such as “having,” “comprising”, etc. do not exclude any other elements or steps, and terms such as “a” or “an” do not exclude a plurality. Furthermore, it is noted that features or steps that have been described with reference to one of the aforementioned embodiments may also be used in combination with other features or steps of other embodiments described above. Reference signs in the claims should not be considered limiting.

1. A method for checking an access authorization for a building or an event, the method comprising:
receiving an access authorization from a configuration device, wherein the access authorization is valid for a participant invited into the building or to the event;
generating a machine-readable code using a server based on the access authorization of the participant invited into the building or to the event;
sending the machine-readable code to a mobile device of the participant by means of the server;
reading in the machine-readable code by means of a control device and decoding the machine-readable code;
checking whether the machine-readable code authorizes the participant to access the building and/or or event;
identifying participant information by means of the server based on the machine-readable code; and
displaying the participant information by means of the control device such that the participant information can be is capable of being checked by a controller with respect to the participant.

2. The method according to claim 1, further comprising:
storing data relating to the access authorization on the server if the access authorization has been generated for the participant; and
sending an electronic invitation to the mobile device of the participant after storage, wherein the electronic invitation contains the machine-readable code.

3. The method according to either claim 1 or claim 2, wherein the server or the control device checks whether the machine-readable code authorizes access.

4. The method according to claim 1, wherein participant information for the participant is stored on the server; wherein the server identifies the participant information that is assigned to the machine-readable code and sends said information to the control device.

5. The method according to claim 1, wherein the machine-readable code is a graphical code or wherein data in the machine-readable code are encoded in a two-dimensional matrix; wherein the machine-readable code is capable of being captured by means of a camera of the control device, and image data generated by the camera are decoded.

6. The method according to claim 1, wherein the participant information is intended to be checked by the controller or wherein the participant information comprises a first name, a surname, an image or a personal characteristic of the participant.

7. The method according to claim 1, wherein the control device is a mobile device.

8. The method according to claim 1, further comprising:
generating an additional machine-readable code in response to the machine-readable code read in first being recognized as valid during checking;
sending the additional machine-readable code to the participant mobile device of the participant;
reading in the machine-readable code displayed by the mobile device of the participant by means of the control device and decoding the additional machine-readable code; and
checking whether the additional machine-readable code authorizes access to the building or event.

9. The method according to claim 8, wherein a validity of the additional machine-readable code is limited in time.

10. The method according to claim 1, further comprising:
marking the access authorization as used if the machine-readable code has been checked or displaying the access authorization as used if the same machine-readable code is checked again.

11. The method according to claim 1, further comprising:
defining an event using an application run on a server, wherein a plurality of participants are assigned to the event; and
sending an electronic invitation comprising the machine-readable code to a participant mobile device of each of the participants, wherein machine-readable codes of various participants differ from one another.

12. The method according to claim 10, further comprising:
assigning a participant to a participant category when defining the event; and
sending the participant category of a participant determined from the machine-readable code to the control device in response to the machine-readable code being checked.

13. A computer program which, when executed on one or more processors, is designed to carry out a method comprising:
receiving an access authorization from a configuration device, wherein the access authorization is valid for a participant invited into the building or to the event;
generating a machine-readable code using a server based on the access authorization of the participant invited into the building or to the event;
sending the machine-readable code to a mobile device of the participant by means of the server;
reading in the machine-readable code by means of a control device and decoding the machine-readable code;
checking whether the machine-readable code authorizes the participant to access the building and/or event;
identifying participant information by means of the server based on the machine-readable code; and
displaying the participant information by means of the control device such that the participant information is capable of being checked by a controller with respect to the participant.

14. The computer program of claim 13, wherein the computer program is stored on a computer-readable medium.

15. A system for checking an access authorization for a building and/or an event, the system comprising:
a server, on which a plurality of access authorizations are stored, wherein each access authorization is assigned to a participant and linked to participant information for said participant;
a configuration device, which is designed to exchange information with the server; and
a control device, which is designed to exchange information with the server;
wherein the server is designed to receive the access authorizations from the configuration device, generate a machine-readable code based on one of the access authorizations and send said code to a participant mobile device of the assigned participant;
wherein the control device is designed to read in a machine-readable code;
wherein the system is designed to decode the machine-readable code to check whether the machine-readable code authorizes the participant to access the building and/or or event and to identify participant information based on the machine-readable code;
wherein the control device is designed to display the participant information that was identified based on the read-in machine-readable code, such that the participant information is capable of being checked by a controller with respect to the participant.
